(19) United States
(12) Patent Application Publication
(10) Pub. No.: US 2025/0257298 A1
(43) Pub. Date: Aug. 14, 2025

(54) Regenerative Filter System For Distilled Spirits

(71) Applicants: Jeffrey L. Kavanaugh, Colleyville, TX (US); Steven M. Kavanaugh, Evansville, IN (US)

(72) Inventors: Jeffrey L. Kavanaugh, Colleyville, TX (US); Steven M. Kavanaugh, Evansville, IN (US)

(21) Appl. No.: 18/937,952

(22) Filed: Nov. 5, 2024

Related U.S. Application Data
(60) Provisional application No. 63/552,843, filed on Feb. 13, 2024.

(51) Int. Cl. C12H 1/07; C12H 1/04

(52) U.S. Cl. CPC C12H 1/063; C12H 1/04

(57) ABSTRACT

A filtration system comprising activated charcoal and alternating filtering and regenerating modes for sustainable filtering of a spirit distillate. The filtering mode is a reverse-gravity filtration method wherein distillate is pumped upward from a bottom end of a filter chamber to a top end of the filter chamber and wherein the filter chamber comprises activated charcoal of various pore sizes to capture impurities from the distillate. The cleaning mode is a gravity-flow steam-regeneration method wherein steam flows downward from the top end of the filter chamber to the bottom end of the filter chamber regenerating the activated charcoal. The system alternates between the reverse-gravity filtration method and gravity-flow steam regeneration method through the use of a series of input and output ball valves at the top end of the filter chamber and a series of input and output ball valves at the bottom end of the filter chamber.

### CROSS-REFERENCE TO RELATED APPLICATIONS

This application claims the benefit of U.S. Provisional Application No. 63/552,843, filed on Feb. 13, 2024, the disclosures of which are incorporated herein by reference.

### FIELD OF THE DISCLOSURE

The present invention pertains to a filtration and cleaning system, including an apparatus and methods, designed to purify distilled spirits, particularly vodka, while conserving materials and minimizing waste.

### BACKGROUND

The production of spirits generally involves two separate processes—fermentation and distillation. Alcohol is produced during fermentation then concentrated and purified through distillation. Sometimes, distillation results in the final spirits product to be bottled and sold. Other times, distilled spirits may be further aged or flavored. The quality of a finished spirits product, in terms of visual aesthetics, smell, and taste, is considered to be a function of the quality of the filtration process that occurs after distillation.

Prior art filtration processes and prior art filters for distilled spirits often result in the final product having impurities that negatively impact the overall quality of the finished spirits product and also result in unnecessary waste. For example, newly distilled vodka (i.e., a grain neutral spirit) often has impurities which carry undesirable aromatic and taste characteristics. Even for filtered products these impurities may not be immediately evident, but benign particles may persist even after filtering, negatively affecting the visual aesthetic and aromatic appeal of the vodka spirit.

It is accordingly the object of this invention to develop a novel regenerative filtration system that improves upon current filtering and cleaning processes and includes a novel filter and novel, sustainable methods for using the filter. Specifically, it is an object of this invention to create a filter chamber and system for using the filter chamber to remove impurities from a spirits distillate, including a vodka distillate, and create a finished spirits product having no discernable (unpleasant) taste. It is a further object of this invention to create a filtration and cleaning system that conserves materials and minimizes waste output.

### SUMMARY OF INVENTION

The objects of this invention are achieved by the preferred embodiments disclosed herein concerning a system for the filtration of a spirits distillate. This invention is a closed, vertical regenerative filtration system utilizing activated charcoal having various pore sizes; qualitative filter paper; steam regeneration; and a series of ball valves to rapidly alternate between a reverse-gravity filtration mode and a gravity-flow steam regeneration mode. In the preferred embodiment, the system includes a vertically oriented, generally tubular stainless steel filter chamber having a bottom end and a top end, a bottom end cap that encloses the bottom end of the filter chamber, and a top end cap that encloses the top end of the filter chamber. The filter chamber further comprises a filter chamber column positioned between the top end cap and bottom end cap, wherein the filter chamber column is generally cylindrical and has an upper end and lower end.

In the preferred embodiment, the filter chamber further comprises a bottom end screened gasket positioned between the bottom end cap and the lower end of the filter chamber column and a top end screened gasket positioned between the top end cap and the upper end of the filter chamber column. In the preferred embodiment, the filter chamber column further comprises activated charcoal, wherein the position of the activated charcoal in the filter chamber column is physically supported at the upper end of the filter chamber column by the top end screened gasket and physically supported at the lower end of the filter chamber column by the bottom end screened gasket. In alternative embodiments, the filter chamber may further comprise a first qualitative filter paper positioned between the bottom end screened gasket and lower end of the filter chamber column for further filtering of the distillate. In some embodiments, the filter chamber may further comprise a second qualitative filter paper positioned between the upper end of the filter chamber column and the top end screened gasket for further filtering of the distillate.

In the preferred embodiment, the filtration system further comprises the bottom end cap and top end cap of the filter chamber having a series of inlet and outlet valves for fluids to enter and exit the filter chamber; an explosion-proof air-driven pump for transferring a distillate from a chilled input vessel to the filter chamber; a finished spirits reservoir for housing the distillate after filtering; a boiler for generating steam to be used for regeneration (or cleaning) of the activated charcoal; a drain for fluids used during regeneration to discharge; and transfer tubing. In alternative embodiments, the regenerative filtration system may be further configured to incorporate multiple filter chambers in a series to increase volume and purity. In the preferred embodiment, the filter chamber is made of stainless steel. In alternative embodiments, the filter chamber may be made of any material having chemical resistance and high-temperature tolerance qualities similar to stainless steel.

In the preferred embodiment, during the reverse-gravity filtration mode, a vodka distillate moves upward from the bottom end of the filter chamber to the top end of the filter chamber through the filter chamber column as the result of pressure from an explosion-proof air-driven pump. Using pressure to pump the distillate upward against gravity has an advantage over prior art methods in that it allows the flow of the distillate through the activated charcoal in the filter chamber column to be controlled more easily than in a downward flow filter system. The filter chamber column further comprises activated charcoal which, due to its physical and chemical properties, removes impurities from the distillate. In the preferred embodiment, the activated charcoal consists of a variety of particle and pore sizes for removing different levels of impurities from the distillate. In the preferred embodiment, the activated charcoal pore sizes range from 0.4 mm to 1.4 mm. In alternative embodiments, the reverse-gravity filtration mode further utilizes qualitative filter paper for further removal of larger impurities from the distillate. Upon exiting an outlet valve on the top end cap of the filter chamber, the newly filtered distillate is transferred to a finished spirit reservoir through transfer tubes at which point the finished spirit may be bottled or further aged and/or flavored.

In the preferred embodiment of the regenerative filtration system, to improve the capability of the filter system to capture maximum impurities, a vodka distillate is chilled in a chilled input vessel before entering the filter chamber. In the preferred embodiment, the temperature of the distillate in the chilled input vessel is less than 4° Celsius or 390 Fahrenheit. In the preferred embodiment, the distillate is transferred from the chilled input vessel through a first transfer tube to an explosion-proof air-driven pump. From the explosion proof pump, the distillate is transferred to the filter chamber through a second transfer tube. The distillate enters the filter chamber through a first inlet valve on the bottom end cap of the filter chamber. The first inlet valve comprises a first ball valve. In the preferred embodiment, the distillate is pumped upward from the bottom end of the filter chamber to the top end of the filter chamber and exits the filter chamber through a first outlet valve on the top end cap of the filter chamber. The first outlet valve comprises a second ball valve. Upon exiting the first outlet valve, the newly filtered distillate is transferred to a finished spirits reservoir via a third transfer tube.

In the gravity-flow steam regeneration mode, steam from a boiler flows from the boiler through a fourth transfer tube to the filter chamber and enters the top end of the filter chamber via a second inlet valve on the top end cap of the filter chamber. The second inlet valve comprises a third ball valve. Upon entering the top end of the filter chamber, the steam flows from the top end of the filter chamber to the bottom end of the filter chamber through the filter chamber column. Initially, the steam converts to liquid water as it flows downward from the upper end of the filter chamber column to the bottom end of the filter chamber. As steam continues to enter the top end of the filter chamber, however, the filter chamber column and activated charcoal therein gradually increase in temperature until the flow of fluid changes from a mixture of liquid water and steam to comprise nearly 100% steam. The fluid exits the bottom end of the filter chamber through a second outlet valve on the bottom end cap of the filter chamber, said second outlet valve comprising a fourth ball valve. Upon exiting the second outlet valve, the fluid is transferred to a drain through a fifth transfer tube. Additional pressure is not needed in the gravity-flow steam regeneration mode beyond what is naturally generated by the boiler. This process regenerates, or cleans, the activated coal for indefinite reuse.

In the novel regenerative filtration system, alternation between the reverse-gravity filtration mode and gravity-flow steam regeneration mode is aided by the two inlet valves and two outlet valves wherein the first inlet valve and first outlet valve open during the reverse-gravity filtration mode and close during the gravity-flow steam-regeneration mod and wherein the second inlet valve and second outlet valve close during the reverse-gravity filtration mode and open during the gravity-flow steam-regeneration mode.

Further areas of applicability will become apparent from the detailed description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 shows a front perspective view of the generally elongated filter chamber (1).

FIG. 2 shows a schematic view of the regenerative filtration system comprising a reverse-gravity filtration mode (1a).

FIG. 3 shows a schematic view of the gravity-flow steam regeneration mode (12).

FIG. 4 shows a schematic view of the regenerative filtration system comprising the reverse-gravity filtration mode (1a) and the gravity-flow steam regeneration mode (12).

FIG. 5 shows a top plan view of a mixture activated charcoal (14) having a variety of pore sizes.

FIG. 6 shows a top plan view of a bottom-end screened gasket (3a).

FIG. 7 shows a top plan view of a first qualitative paper (3c).

### DETAILED DESCRIPTION

The following description and drawings illustrate embodiments sufficiently to enable those skilled in the art to practice the invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense.

Also, it is to be understood that the phraseology and terminology used herein is for the purpose of description and should not be limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

For purposes of the inventions disclosed herein, a “spirit” means an alcoholic beverage that is produced by distillation, and includes, but is not limited to, vodka, tequila, rum, gin, whiskey, and bourbon. For purposes of the inventions disclosed herein, a “distillate” includes a distilled spirit that may be unfiltered or filtered. For purposes of the inventions disclosed herein, a “finished spirit” means a distillate that has been filtered utilizing the regenerative filtration system disclosed herein. For purposes of the inventions disclosed herein, a “fluid” means a gas or liquid capable of flow.

### Description of the Vertically Oriented Filter Chamber

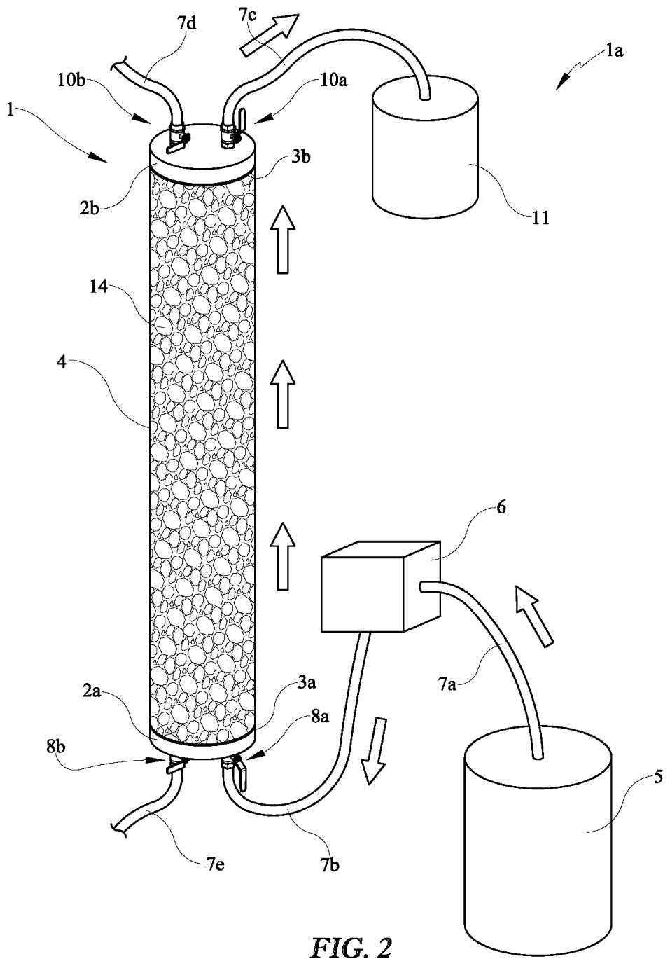

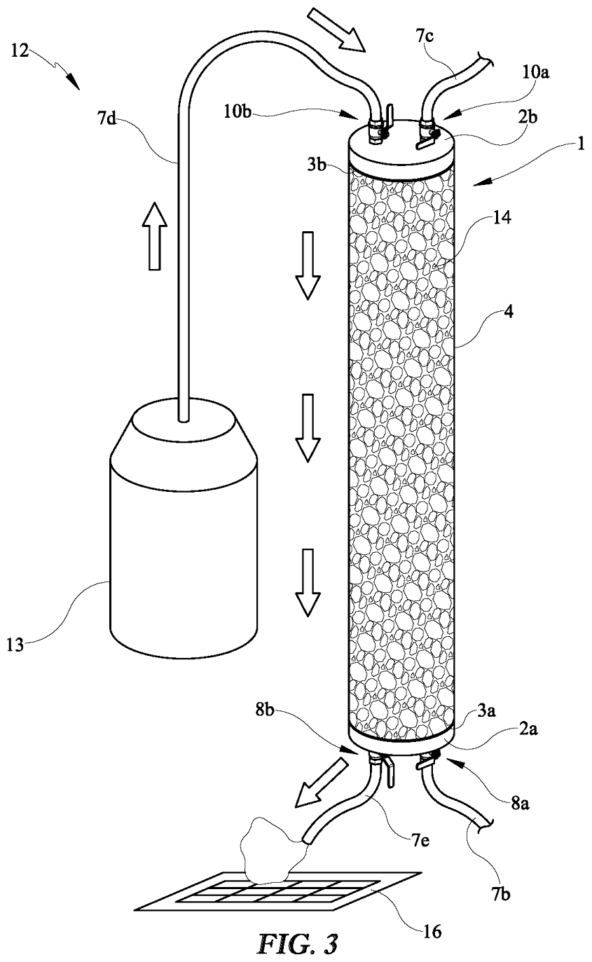

The heart of this novel filtration system is a vertically oriented, generally tubular filter chamber. As shown in FIGS. 2-3, the filter chamber (1) may be used in connection with a novel reverse-gravity filtration mode (1a) to filter a distillate. Said reverse-gravity filtration mode (1a) comprises a chilled input vessel (5) for holding a distillate, an explosion-proof air-driven pump (6) for transferring the distillate from the chilled input vessel to the filter chamber (1), wherein the chilled input vessel (5) is connected to the explosion-proof air driven pump (6) via a first transfer tube (7a) and wherein the explosion-proof air-driven pump (6) is further connected to the filter chamber (1) via a second transfer tube (7b).

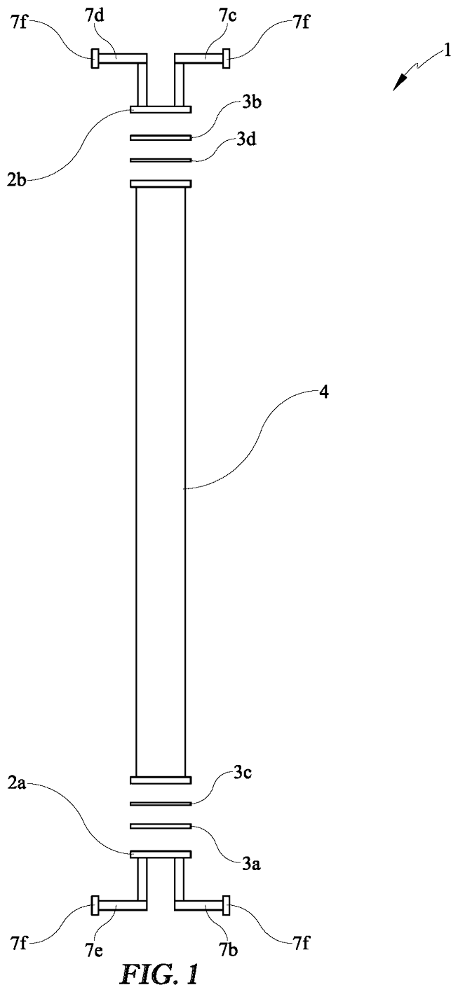

As shown in FIG. 1, the filter chamber (1) has a top end and a bottom end, a bottom end cap (2a) enclosing the bottom end of the filter chamber, and a top end cap (2b) enclosing the top end of the filter chamber, said caps being generally circular. The filter chamber (1) further comprises a generally cylindrical, hollow filter chamber column (4), having an upper end and a lower end. As shown in FIG. 1, the filter chamber column (4) is positioned between the top end cap (2b) and the bottom end cap (2a), wherein the lower end of the filter chamber column is proximal to the bottom end cap (2a) and the upper end of the filter chamber column is proximal to the top end cap (2b). As shown in FIG. 1, the filter chamber (1) further comprises a generally circular, bottom end screened gasket (3a) positioned between the bottom end cap (2a) and the lower end of the filter chamber column (4) and a generally circular, top end screened gasket (3b), positioned between the top end cap (2b) and the upper end of the filter chamber column (4).

In some embodiments, a first connector is attached to the upper end of the filter chamber column wherein said first connector is a ferrule. In some embodiments, a second connector is attached to the lower end of the filter column, wherein said second connector is a ferrule. Ferrules include rings, typically made of metal, which are used to strengthen the end of a tube and may be capable of connecting with other connectors. Ferrules are commercially available. In the preferred embodiment, the filter chamber column has a diameter of about 3 inches and a length of about 36 inches and each of the upper end and lower end of the filter chamber column is attached to a ferrule having a 3-inch diameter.

In the preferred embodiment, as described further herein and shown in FIGS. 2-4, the filter chamber column (4) further comprises activated charcoal (14) having various pore sizes for filtering impurities from the distillate. In the preferred embodiment, as shown in FIGS. 2-4, the bottom end screened gasket (3a) provides physical support for the activated charcoal at the lower end of the filter chamber column, and top end screened gasket (4a) provides physical support for the activated charcoal at the upper end of the filter chamber column.

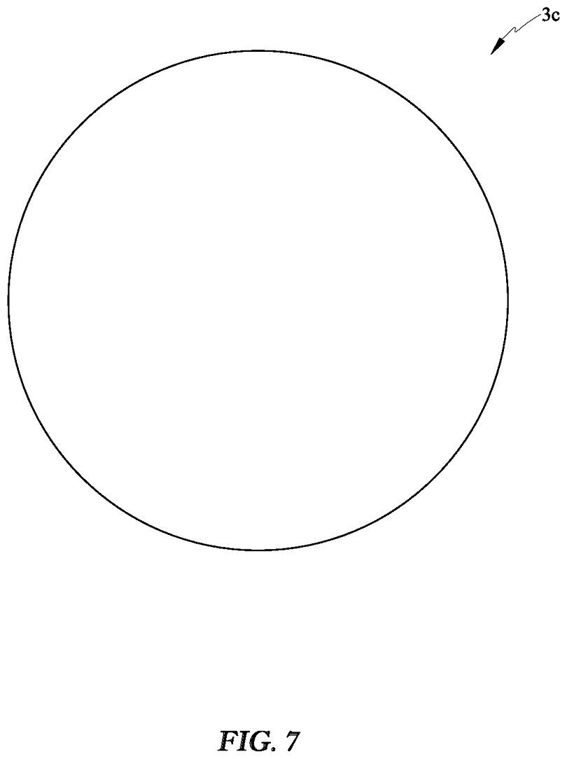

As shown in FIG. 1, in some embodiments, the filter chamber (1) further comprises a first qualitative filter paper (3c) positioned between the bottom end screened gasket (3a) and the lower end of the filter chamber column (4). In some embodiments, the filter chamber (1) further comprises a second qualitative filter paper positioned (3d) between the upper end of the filter chamber column (4) and the top end screened gasket (3b). The first and second qualitative filter papers are selected for easy installation and replacement (though non-standard diameters may require manually cutting the paper to fit the filter diameter). As shown in FIG. 7, the qualitative filter paper is generally circular. In the preferred embodiment, generally circular qualitative filter paper having a 3-inch diameter is used.

As further shown in FIG. 2, the bottom end cap of the filter chamber (2a) further comprises a first inlet valve (8a) for a distillate to flow into the bottom end of the filter chamber (1). In the preferred embodiment, the first inlet valve comprises a ball valve capable of being in an open or closed position. In some embodiments, the first inlet valve (8a) is connected to the second transfer tube (7b), wherein the second transfer tube has a proximal and distal end, and wherein said proximal end is connected to the first inlet valve (8a) and the distal end is connected to the explosion-proof, air driven pump (6).

As shown in FIG. 2, the top end cap (2b) of the filter chamber further comprises a first outlet valve (8b) for distillate to exit the top end of the filter chamber. In some embodiments, the first outlet valve (8b) comprises a second ball valve capable of being in an open or closed position. In some embodiments, the first outlet valve (8b) may be connected to a third transfer tube (7c) having a proximal and distal end, wherein the proximal end of the third transfer tube (7c) is connected to the first outlet valve (8b) and the distal end of the third transfer tube (7c) connected to the finished spirits reservoir (11).

As described herein and shown in FIG. 3, the filter chamber may be used in a gravity-flow regeneration process (12) wherein steam is used to clean the activated coal (14). Accordingly, as shown in FIG. 3, the top end cap (2b) of the filter chamber (1) further comprises a second inlet valve (10a) for steam to enter the filter chamber. In some embodiments, the second inlet valve (10a) comprises a third ball valve capable of being in an open or closed position. In some embodiments, the second inlet valve (10a) is connected to a fourth transfer tube (7d), having a proximal and distal end, wherein the proximal end of the fourth transfer tube (7d) is attached to the second inlet valve (10a) and the distal end of the third transfer tube (7c) is connected to a boiler (13).

As further shown in FIG. 2, the bottom end cap (2a) of the filter chamber further comprises a second outlet valve (10b) for steam to flow out of, or exit, the filter chamber. In some embodiments the second outlet valve comprises a fourth ball valve capable of being in an open or closed position. In some embodiments, the second outlet valve (10b) is connected to a fifth transfer tube (7e), having a proximal and distal end, wherein the proximal end of the fifth transfer tube (7e) is connected to the second outlet valve (10b) and the distal end of the fourth transfer tube (7e) is connected to a drain (15).

The proximal and distal ends of the transfer tubes (7a-7e) may further comprise connectors, including ferrules. In the preferred embodiment, the transfer tube pipes have %-inch diameters and are made of chemical resistant and high-temperature tolerant tubing material. In the preferred embodiment, the connectors are h-inch tri-clamp ferrules.

In the preferred embodiment, as shown in FIG. 1, the transfer tube pipes (7a-7d) are bent to 90 degrees in an arced design to maximize fluid flow. In alternative embodiments, other designs may be utilized.

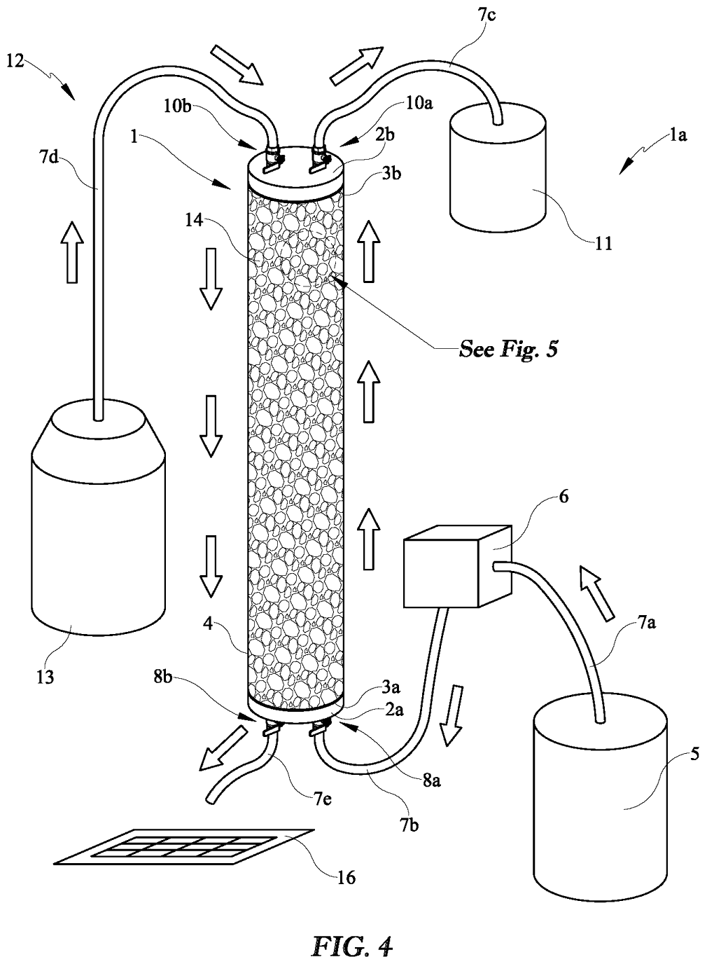

As described herein, and shown in FIG. 4, the flow of the distillate (for filtering) or steam (for cleaning) in the filter chamber is controlled through the inlet and outlet valves (8a, 8b, 10a, and 10d), wherein each of the inlet and outlet valves comprise an opening and a ball valve, capable of being in an open or closed position. As further described herein, the first inlet valve (8a) and first outlet valve (8b) open for filtering and close for regenerating, or cleaning. As further described herein, the second inlet valve and second outlet valve close for filtering and open for regenerating, or cleaning. By way of example, and not limitation, the following ball valves may be used: WUXUN-Valve ½ ¾ 1 1½ 2-inch OD 304 Stainless Steel Sanitary Full Port 2-Way Ball Valve Fit 25.4/50.5/64 mm Tri Clamp Type Weld Ferrule.

As shown in FIGS. 2-4, in the regenerative filtration system described herein, the filter chamber may be used in two different modes, a filtering mode and a regenerating, or cleaning, mode. As shown in FIGS. 2 and 4, in the reverse-gravity filtration mode (1a), an explosion proof air-driven pump (6) moves distillate upward from the bottom end of the filter chamber (1) to the top end of the filter chamber (1). As shown in FIGS. 3 and 4, in the gravity-flow steam regeneration mode (12), steam from a boiler (13) is transported to the filter chamber (1) and flows downward from the top end to the bottom end of the filter chamber (1) through the filter chamber column (4) for the regeneration, or cleaning, of activated charcoal (14). No additional pressure is necessary to move the steam in the gravity-flow steam-regeneration mode beyond what is naturally generated by the boiler.

### Reverse-Gravity Filtration Mode

As depicted in FIG. 2, in the reverse-gravity filtration mode (1a) a distillate is transferred from the chilled input vessel (5) to the filter chamber (1) via the explosion-proof air-driven pump (6).

In the preferred embodiment, the distillate in the chilled input vessel is chilled to improve the capability of the filter chamber to capture maximum impurities. By cooling the distillate to lower temperatures, the filter chamber is able to remove compounds that can cause cloudiness or haze in the distillate when cooled or mixed with water. At lower temperatures, these compounds, including fatty acids, proteins, and other congeners, may precipitate out of the distillate. At lower temperatures, the impurities coagulate, making them easier to filter out, resulting in a clearer and more aesthetically and aromatically pleasing final product. This process of cooling the distillate before filtering is referred to herein as chill filtering. In the preferred embodiment, the distillate is a vodka distillate and is lowered to a temperature in the range 0° C. to 4° C. (32° F. to 39.2° F.).

The necessity of chill filtering for distillates, including vodka, is primarily determined by the alcohol proof or concentration. The inventors conducted multiple batches of non-chilled filtration with high-quality results. However, some of the non-chill filtered vodka distillates later showed cloudiness in the liquid. Based on the inventor's research and direct experimentation, chill filtering is best used with vodka botted at 80 proof and other spirits at alcohol levels below 92 proof. At alcohol levels below 92 proof, the likelihood of congeners and fatty acids forming a haze or cloudiness when the spirit is cooled increases. In alternative embodiments, involving higher-proof distillates, typically above 46% alcohol by volume (abv) or above 92 proof, chill filtering may not be necessary.

As shown in FIG. 2, in the reverse-gravity filtration mode (1a), the distillate is transported from the chilled input vessel (5) to the filter chamber (1) via the explosion-proof air-driven pump (6). Pressure from the explosion-proof air-driven pump moves the distillate from the bottom end to the top end of the filter chamber (1). In the reverse-gravity filtration mode, an explosion-proof air-driven pump especially designed for pumping or safely moving spirits is the preferred method of transferring spirits that are 60 proof or stronger. In the preferred embodiment, the explosion-proof air-driven pump (6) is of a sufficient rating for head and for upward force capability to move spirits ranging up to at least 95% abv through the filter chamber and into the finished spirits reservoir.

Explosion-proof air-driven pumps suitable for use in the invention may employ carbon dioxide or dry compressed air and have an operating pressure range of 20-100 psi. Said explosion-proof air-driven pumps may further include at least an internal container part that directs the flow of distillate through the pump, a fluid input valve where fluid enters the pump, and a fluid discharge valve where fluid exits the pump, wherein said fluid input and discharge valves are capable of connecting with transfer tubing.

Explosion-proof air-driven pumps suitable for use in connection with the regenerative filtration system described herein are commercially available and include, for example, the Flojet G70C222A. Examples of such pumps are also described in U.S. Pat. No. 6,343,539 B.

The inventors discovered that moving the distillate in an upward direction, against gravity, through the filter chamber allows the flow of distillate and filtering rate to be controlled more easily than in a gravity-flow filtration method. By varying the pressure to pump the distillate from the bottom end of the filter chamber to the top end of the filter chamber, the filtering rate may also be varied.

Through experimentation, the inventors determined that a filtering rate of about 0.5 gallons of distillate per minute (about 30 gallons per hour) is sufficient to meet general commercial production needs. The novel regenerative filtration system disclosed herein achieved said filtering rates consistently with 15 psi pressure applied to the explosion-proof air-driven pump. Filtering rates may vary with successive filtering cycles, pending the number of impurities accumulated in the filter chamber. In alternative embodiments, other filtering rates may be used depending on such factors as filter chamber length and diameter, the purity of the incoming distillate, the temperature of the incoming distillate, and desired taste profile of the finished spirit product.

Varying air pressure downward to lower filtering rates may increase the effectiveness of the activated charcoal, improving the ability of each granule to trap as much impurities as possible. Lower filtering rates lengthen the time between cleaning cycles and may extend the useful life of the activated charcoal. The inventors discovered that when high-quality alcohol (such as vodka distilled multiple times) is used as the source of the distillate, higher filtering rates did not reduce the quality of the finished spirit. While higher filtering rates are feasible, maintaining filtering rates such as 0.5 gallons per minute may reduce activated charcoal degradation and allow the charcoal to sustain adsorption capacity for a longer time period. The inventors determined that when a high-quality alcohol is used as the source of the distillate and is used with a filter chamber having a 3-inch diameter, the reverse-gravity filtration mode is capable of filtering at least 60 gallons of finished spirit (at 40% abv or 80 proof) before the gravity-flow steam regeneration mode is required to regenerate, or “clean,” the activated charcoal.

### Characteristics of Activated Charcoal as Filter Material

A novel aspect of the regenerative filtration system disclosed herein includes using activated charcoal having various pore sizes. As shown in FIGS. 2-4, the filter chamber column (4) comprises activated charcoal (14) having various pore sizes to remove impurities. Due to its unique chemical and physical properties, activated charcoal (14) provides for excellent filtering when used in the reverse-gravity filtration mode (1a).

Activated charcoal is preferred by the inventors due to its high adsorption capacity, ability to improve taste and clarity, and its effectiveness in maintaining the spirit's essential characteristics. Adsorption is molecular transfer from fluid to solid surface; e.g., for vodka filtration, this means activated charcoal pores trap impurities in the vodka distillate.

At its core, activated charcoal has an extremely porous structure, providing a vast surface area in a relatively small volume. This immense surface area is key to its effectiveness, as it allows for the adsorption of a wide range of impurities, including organic compounds and congeners, which are by-products of the fermentation process that can adversely affect the taste and quality of vodka.

The porous nature of activated charcoal also makes it adept at removing volatile organic compounds (VOCs) and other flavor-altering substances from spirts such as vodka. This results in a smoother, cleaner tasting spirit, which is highly desirable in premium vodka products. Furthermore, activated charcoal can effectively remove color impurities, ensuring that the vodka remains clear and visually appealing, a critical attribute for high-quality vodka.

Another significant advantage of using activated charcoal is its ability to selectively remove unwanted components without altering the fundamental character of spirits, particularly vodka. It achieves this by adsorbing impurities while allowing the desired ethanol and water components to pass through, thus preserving the intrinsic qualities of the spirit.

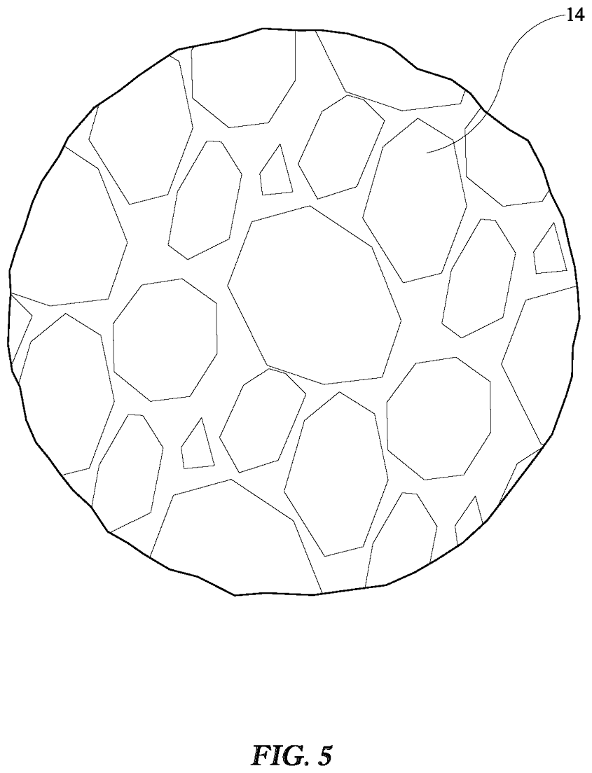

As shown in FIG. 5, the inventors have discovered that activated charcoal's filtration characteristics can be enhanced through the use of a combination of particle radius and corresponding pore sizes. Porous carbons are classified into microporous (pore size of <2 nm), mesoporous (2-50 nm), and macroporous (>50 nm) carbons. The incorporation of activated charcoal in these various pore sizes presents a multi-faceted approach to purifying and enhancing the quality of spirits such as vodka. The novel regenerative filtration system described herein utilizes the distinct properties of each charcoal size to achieve comprehensive and efficient filtering.

In addition to pore size, another consideration in the selection of activated charcoal is grain size, or size of the overall particle. The inventors use 0.4-1.4 mm grain size, which is widely available and lasts longer, as particle size tends to gradually decrease over time. Because the granules gradually become smaller with each use, in the preferred embodiment of the invention, the 0.4-1.4 mm premium activated charcoal (12×40 mesh) is used. Said granules are slightly larger than the smaller 0.4-0.85 mm grain. Selecting the slightly larger grain size of 0.4-1.4 mm range permits the activated charcoal to be reused many times. Larger particle sizes of activated charcoal tend to have a longer lifespan within the filtration system. They are also more amenable to the steam regeneration process, retaining their structural integrity and adsorption capability over multiple regeneration cycles.

Smaller grain sizes, however, may be used in connection with the filtration system disclosed herein.

In the preferred embodiment, the activated charcoal comprises a mixture of microporous activated charcoal, mesoporous activated charcoal and macroporous activated charcoal, as defined further below. As shown in FIGS. 2-4, in the preferred embodiment, activated charcoal (14) comprises nearly 100% of the volume of the filter chamber column. In alternative embodiments, activated charcoal comprises 75%-100% of the volume of the filter chamber column.

### Microporous Activated Charcoal

Enhanced Surface Area. Micro-sized charcoal particles (<2 nm pore radius) possess an exceptionally high surface area relative to their volume. This increased surface area allows for a more thorough and efficient adsorption of impurities from the spirit, including congeners and other unwanted organic compounds. The removal of these impurities is crucial for achieving a smooth and clean taste in the final spirits product.

Targeting Fine Impurities. The small size of the micro charcoal enables it to capture finer impurities that larger particles might miss. This is particularly beneficial for removing subtle but impactful elements that contribute to off-flavors or aromas.

### Mesoporous Activated Charcoal

Optimal Flow Rate. Meso-sized charcoal (2-50 nm pore radius) strikes a balance between efficacy and flow rate. The inventors discovered that this pore size is small enough to effectively remove impurities while being large enough to allow for a consistent flow of the spirit, including vodka, through the filtration system. This ensures that the filtration process is both effective and efficient, preventing bottlenecks and ensuring a steady production rate.

Versatility in Impurity Removal. This size of charcoal is adept at removing a wide range of impurities, offering a versatile solution that is effective across different batches of vodka, each with its unique impurity profile.

### Macroporous Activated Charcoal

Large Impurity Capture. Macro-sized charcoal (>50 nm pore radius) is particularly effective at capturing larger impurities. These might include larger organic molecules or particulates that are present in the spirit before distillation. The removal of these larger impurities is crucial for ensuring the clarity and visual appeal of the final spirits product, including a vodka product.

Larger charcoal particles tend to have a longer lifespan within the filtration system. They are also more amenable to the steam regeneration process, retaining their structural integrity and adsorption capability over multiple regeneration cycles.

As shown in FIG. 5, the inventors discovered that combining microporous, mesoporous, and macroporous sizes of activated charcoal enhances filtration, wherein each pore size targets specific impurities. Such a mixture of activated charcoal ensures a more thorough purification compared to using a single size of activated charcoal. The result is a finished spirit, especially a vodka, that is clearer and smooth tasting, a higher quality relative to products using a less comprehensive filtration approach. For clarity, the regenerative filtration system and methods disclosed herein do not require an exact configuration of specified quantities of activated charcoal having specifically defined pore sizes. Rather, various mixtures of microporous, mesoporous, and microporous activated charcoal may be utilized in connection with the filtration system disclosed herein to take advantage of their complementary adsorption capabilities. The inventors further discovered that the utilization of activated charcoal having a variety of pore sizes, including microporous, mesoporous, and macroporous, significantly enhances the purity, taste, and quality of the finished spirit product, particularly vodka.

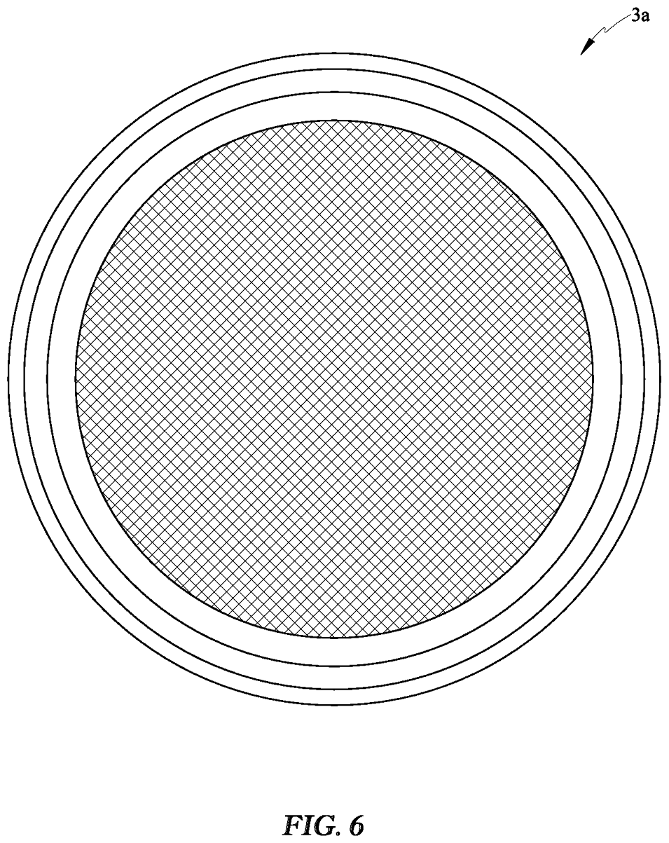

To complement the filtering capabilities of activated charcoal, the reverse-gravity filtration mode, as shown in FIGS. 2 and 4, further utilizes a bottom end screened gasket (3a) and a top end screened gasket (3b). A top plan view of the bottom end screened gasket (3a) is shown in FIG. 6. In the preferred embodiment, the top end screened gasket (3b) is identical to the bottom end screened gasket (3a) as shown in FIG. 6.

As shown in FIGS. 1 and 7, the reverse-gravity filtration mode (1a) may further utilize first and second qualitative filter papers (3c and 3d) made of cellulose fiber to improve filtration quality. Said first and second qualitative filter paper (3c and 3d) act as physical barriers, trapping particles based on size and are effective to filter larger particulates and sediments.

As shown in FIGS. 1 and 2, in the reverse-gravity filtration mode (1a), upon entering the bottom end of the filter chamber (1) through the first inlet valve (8a), the distillate moves upward against gravity from the bottom end of the filter chamber to the top end of the filter chamber through the bottom end screened gasket (3a), first qualitative filter paper (3c), filter chamber column (4), second qualitative paper (3d), and top end screened gasket (3b), whereby any impurities are removed. Thereafter, the distillate exits the filter chamber (1) through the first outlet valve (10a) as a finished spirit and is transferred to the finished spirit reservoir (11) via a third transfer tube (7c).

### Gravity-Flow Steam-Regeneration Mode

After single or multiple uses of the reverse-gravity filtration mode to create filtered spirits, the activated charcoal may need to be replaced or cleaned. Although replacing the activated charcoal within the filter chamber column is an option after the reverse-gravity filtration mode is complete, this approach has several drawbacks. First, it takes time to remove the polluted material and replace it with clean material. Second, activated charcoal is expensive to replace, particular for high-volume operations. Finally, it is environmentally not sustainable to replace activated charcoal that can be reused economically.

The inventors have discovered a cost-effective and sustainable solution involving the regeneration of activated charcoal. As shown in FIG. 3, in the gravity-flow steam-regeneration mode (12), the filter chamber (1) is cleaned through steam regeneration, wherein the steam flows in the opposite direction of the distillate, to release the impurities accumulated through adsorption (via activated charcoal) and physical entrapment (via filter paper). In this mode, steam is generated by a boiler (13) capable of heating water from room temperature to 212° F. or higher. The inventors discovered that, for ten (10) gallons of water heated by two 1.5 kW (120V) heating elements, the time to reach steam is about two hours.

As shown in FIGS. 3 and 4, in the gravity-flow steam-regeneration mode (12) steam is transported via a fourth transfer tube (7d) from the boiler (13) to the second inlet valve (10b), wherein steam enters the top end of the filter chamber and flows downward from the top end of the filter chamber to the bottom end of the filter chamber. At the initiation of the gravity-flow steam-regeneration mode (12), the filter chamber (1), including the filter chamber column (4) and activated coal (14) is at ambient temperature. Accordingly, as the steam flows downward from the top end of the filter chamber, it initially cools to liquid water upon encountering the filter chamber column (4) and activated charcoal (14). After this initial cooling, the liquid water trickles downward through the filter chamber column (4) and exits the bottom end of the filter chamber via the second outlet valve (8b) as nearly 100% liquid water. As steam continues to enter the top end of the filter chamber, however, the temperature of the filter chamber column (4) and activated charcoal (14) increases. This heating of the filter chamber column (4) and the activated charcoal (14) continues throughout the length of the filter chamber column until the activated charcoal reaches the temperature of the steam, at which point the steam continues to flow downward to the bottom end of the filter chamber (1) and exits the filter chamber (1) via the second outlet valve (8b), as nearly 100% steam. In the gravity-flow steam-regeneration mode, upon exiting the second outlet valve (8b), the fluid (steam and/or liquid water) is transported to a drain (16) via a fifth transfer tube (7e).

In the preferred embodiment, once the fluid discharging into the drain (16) comprises nearly 100% steam, the gravity-flow steam-regeneration mode (12) continues for an additional 60 minutes. At the conclusion of the 60 minutes, the activated charcoal (14) is regenerated to a clean, porous state and is ready to resume filtration in the reverse-gravity filtration mode (1a). In other embodiments, the duration of the gravity-flow steam-regeneration mode may vary based on volume of steam, volume of activated charcoal, and extent of activated charcoal pollution.

In yet other embodiments, the odor of the fluid discharging into the drain (16) as shown in FIGS. 3 and 4 may be used to determine the duration of the gravity-flow steam-regeneration mode. When the gravity-flow steam-regeneration mode begins, impurities that have been captured from the distillate are flushed from the activated charcoal, and, as a result, the discharging fluid may have a foul odor. As the gravity-flow steam regeneration mode continues, the foul odor diminishes as less and less impurities remain in the activated charcoal until eventually the foul odor can no longer be detected in the discharging fluid.

The inventors have discovered that additional pressure is not needed in the gravity-flow steam-regeneration mode, beyond what is naturally generated by the boiler in creating steam. In the preferred embodiment, the inventors discovered that 120V electricity with two 1.5 kW heating elements provides sufficient power for the boiler to generate steam for the gravity-flow steam-regeneration mode. In alternative embodiments, other forms of heat may be used. For example, one or more 220V 6 kW electric heating elements or a propane gas boiler, may be better options as the length and diameter of the filter chamber grows and as such may generate more steam, with substantially shorter time to reach boiling temperature.

Once the activated charcoal has reached a clean state, the reverse-gravity filtration mode shown in FIGS. 2 and 4 will be ready to be employed, once the second inlet valve (10b) and second outlet (8b) valve have been closed and the first inlet valve (8a) and first outlet valve (10a) have opened. In the preferred embodiment, the first and second inlet and outlet valves comprise ball valves capable of moving from an open position to a closed position. In the open position, the inlet and outlet valves permit the flow of fluids, and in the closed position, the inlet and outlet valves prohibit the flow of fluids. As set forth herein, for purposes of the disclosure of this invention, a fluid means a gas or liquid capable of flow.

### Alternating Between the Reverse-Gravity Filtration Mode and the Gravity-Flow Steam Regeneration Mode

A benefit of the filtration and cleaning system disclosed herein, as shown in FIG. 4, is the ease and efficiency of alternating between the reverse-gravity filtration mode (1a) and gravity-flow steam regeneration mode (12). In the preferred embodiment, the first inlet valve (8a), first outlet valve (10a), second inlet valve (10b), and second outlet valve (8b) are ball valves capable of moving from an open to a closed position, where an open position permits the flow of fluids and a closed position prohibits the flow of fluids. As described herein, commercially available ball valves may be used. Likewise, methods for opening and closing ball valves to control the flow of fluids are known in the art and may be used in connection with the regenerative filtration system and methods disclosed herein.

In the preferred embodiment, the first inlet valve (8a) and first outlet valve (10a) comprise ball valves in an open position during the reverse-gravity filtration mode and a closed position during the gravity-flow steam regeneration mode. In the preferred embodiment, the second inlet valve (8b) and second outlet valve (10b) comprise ball valves in a closed position during the reverse-gravity filtration mode and in an open position during the gravity-flow steam regeneration mode. This design enables simple, rapid switching between operational modes of filtering and regeneration (cleaning).

In the preferred embodiment, as shown in FIG. 1, transfer tubes (7b, 7c, 7d, and 7e) are configured in a 90 degree arced bent design. This design facilitates connections with the inlet and outlet valves.

In alternative embodiments, the transfer tubes as shown in FIG. 1 (7b, 7c, 7d, and 7e) have proximal and distal ends, wherein each of said distal ends further comprise connectors (7f). In other embodiments, each of the proximal and distal ends further comprise connectors. In some embodiments, said connectors may include hose barbs. Alternatively, other connectors known in the art and capable of connecting to a ball valve may be used. As described herein, transfer tubes may be made of any chemically resistant material. Alternatively, special heat rated tubing (like Polytetrafuoroethylene (PTFE)) or stainless-steel transfer tube piping may be used to transfer steam from the boiler to the filter chamber.

The foregoing description of the embodiments has been provided for purposes of illustrations and description. It is not intended to be exhaustive or to limit the disclosure,

What is claimed is:

1. A filter assembly for filtering a spirit distillate comprising:
a vertically oriented, tubular filter chamber having a top end and a bottom end;
a bottom end cap enclosing the bottom end;
a top end cap enclosing the top end;
a filter chamber column positioned between the top end cap and bottom end cap, said filter chamber column having an upper end proximal to the top end cap and a lower end proximal to the bottom end cap;
a bottom end screened gasket positioned between the bottom end cap and lower end of the filter chamber column;
a top end screened gasket positioned between the top end cap and upper end of the filter chamber column;
a mixture of charcoal positioned in the filter chamber column between the bottom end screened gasket and top end screen gasket;
the bottom end cap further comprising a first inlet valve, said first inlet valve including a first ball valve having an open position and a closed position, wherein the open position of the first ball valve permits fluid flow through the first inlet valve and the closed position of the first ball valve prohibits fluid flow through the first inlet valve;
the top end cap further comprising a first outlet valve, said first outlet valve including a second ball valve having an open position and a closed position, wherein the open position of the second ball valve permits fluid flow through the first outlet valve and the closed position of the second ball valve prohibits fluid flow through the first outlet valve;
the top end cap further comprising a second inlet valve, said second inlet valve including a third ball valve having an open position and a closed position, wherein the open position of the third ball valve permits fluid flow through the second inlet valve and the closed position of the third ball valve prohibits the fluid flow through the second inlet valve; and
the bottom end cap further comprising a second outlet valve, said second outlet valve including a fourth ball valve having an open position and a closed position, wherein the open position of the fourth ball valve permits fluid flow through second outlet valve and the closed position of the fourth ball valve prohibits fluid flow through the second outlet valve.

2. An assembly according to claim 1, further comprising a first qualitative filter paper positioned between the bottom end screened gasket and lower end of the filter chamber column and a second qualitative filter paper positioned between the upper end of the filter chamber column and the top end screened gasket.

3. An assembly according to claim 1, wherein the mixture of activated charcoal comprises microporous, mesoporous, and macroporous activated charcoal.

4. An assembly according to claim 1, further comprising,
a chilled input vessel;
an explosion-proof, air-driven pump;
a finished spirits reservoir;
a first transfer tube having oppositely disposed proximal and distal ends, each of said ends further comprising a connector;
a second transfer tube having oppositely disposed proximal and distal ends, each of said ends further comprising a connector; and
a third transfer tube having oppositely disposed proximal and distal ends, each of said ends further comprising a connector;
wherein the chilled input vessel is connected to the explosion-proof, air-driven pump via the first transfer tube; the explosion-proof, air-driven pump is connected to the first inlet valve of the filter chamber via a second transfer tube; and the first outlet valve of the chamber filter is connected to the finished spirits reservoir via a third transfer tube.

5. A regenerative filtration system comprising:
a vodka distillate;
a vertically oriented, tubular filter chamber for filtering the distillate, wherein the filter chamber has a top end, a bottom end, and a filter chamber column between the top end and bottom end, said filter chamber column comprising a mixture of activated charcoal for removing impurities from the distillate;
an explosion-proof air-driven pump for moving the distillate from the bottom end of the filter chamber to the top end of the filter chamber;
a boiler for generating steam to clean the filter chamber, wherein the steam moves from the top end of the filter chamber to the bottom end of the filter chamber;
a plurality of transfer tubes for connecting the explosion-proof air-driven pump, filter chamber, and boiler; and
means for alternating between filtering the distillate and cleaning the filter chamber.

6. The regenerative filtration system of claim 5 wherein the mixture of activated charcoal comprises microporous, mesoporous, and macroporous activated charcoal and the filter chamber further comprises a bottom end screened gasket, a top end screened gasket, and qualitative filter paper for further filtering of the distillate.

7. A closed regenerative filtration system comprising:
a reverse-gravity filtration mode for filtering a distillate, wherein said reverse-gravity filtration mode includes an input vessel for housing the distillate before filtering;
a vertically oriented, tubular filter chamber for filtering the distillate, said filter chamber comprising a top end enclosed by a top end cap, a bottom end enclosed by a a bottom end cap, and a filter chamber column between the top end cap and bottom end cap containing a mixture of activated charcoal for removing impurities from the distillate; an explosion-proof air-driven pump for moving the distillate from the input vessel to the filter chamber and from the bottom end of the filter chamber to the top end of the filter chamber; a first inlet valve on the bottom end cap for the distillate to flow into the filter chamber, said first inlet valve having an open position and a closed position; a first outlet valve on the top end cap for the distillate to flow out of the filter chamber after filtering; said first outlet valve having an open position and a closed position; a finished spirits reservoir for housing the distillate after filtering; and a plurality of transfer tubes for connecting the input vessel, explosion-proof air-driven pump, filter chamber, and finished spirits reservoir;
a gravity-flow steam regeneration mode for cleaning the filter chamber, wherein said gravity-flow steam regeneration mode includes a boiler for generating steam to clean the filter chamber, said steam moving from the top end of the filter chamber to the bottom end of the filter chamber; a second inlet valve on the top end cap of the filter chamber for fluids to flow into the top end of the filter chamber, said second inlet valve having an open and closed position; a second outlet valve on the bottom end cap of the filter chamber for fluids to flow out of the bottom end of the filter chamber, said second outlet valve having an open and closed position; a drain for collecting fluids exiting the filter chamber after cleaning; and a second plurality of transfer tubes for connecting the boiler, filter chamber, and drain; and
means for alternating between the reverse-gravity filtration mode and gravity flow steam regeneration mode, wherein said means includes opening the first inlet and outlet valves and closing the second inlet and outlet valves during the reverse-gravity filtration mode and closing the first inlet and outlet valves and opening the second inlet and outlet valves during the gravity flow steam regeneration mode.

8. The filtration system according to claim 7, wherein the filter chamber further comprises a top end screened gasket, a bottom end screened gasket, and qualitative filter paper for further filtering of the distillate.

9. The filtration system according to claim 8 wherein the distillate is vodka.

10. The filtration system according to claim 7 wherein the mixture of activated charcoal comprises microporous, mesoporous, and macroporous activated charcoal.

11. The filtration system according to claim 7 wherein the activated charcoal fills nearly 100% of the filter chamber column.

12. The filtration system according to claim 10 wherein the activated charcoal fills 75% to 100% of the filter chamber column.

13. The filtration system according to claim 7, wherein the distillate has a temperature of less than 4° C.

14. The filtration system according to claim 7 wherein the reverse-gravity filtration mode filters 0.5 gallons of distillate per minute.

15. The filtration system according to claim 7 wherein the filter chamber has a diameter of about 3 inches.

16. The filtration system according to claim 7 wherein the reverse-gravity filtration mode filters 60 gallons of distillate before alternating to the gravity-flow regeneration mode.

17. The filtration system according to claim 7, wherein the first inlet valve, first outlet valve, second inlet valve and the second outlet valve are ball valves.
